(19) United States
(12) Patent Application Publication
(10) Pub. No.: US 2016/0050503 A1
(43) Pub. Date: Feb. 18, 2016

(54) METHOD FOR INTEGRATING HEARING AID COMPONENTS, AND ELEMENT FOR A HEARING AID

(71) Applicant: SIVANTOS PTE. LTD., SINGAPORE (SG)

(72) Inventor: THOMAS NAETHER, LEMGO (DE)

(21) Appl. No.: 14/825,341

(22) Filed: Aug. 13, 2015

(30) Foreign Application Priority Data
Aug. 13, 2014 (DE) 102014216086.3

(51) Int. Cl. H04R 25/00; B29C 67/00

(52) U.S. Cl. CPC H04R 25/658; H04R 25/608; B29C 67/0051; B29C 67/0077; B29C 67/0092; B29C 67/0085; B33Y 80/00

(57) ABSTRACT

A method for manufacturing an element for a hearing aid and a corresponding element, which has a body and a component. In one step of the method, a relative position of the component on the element is predetermined. A shape and position of a holding device for the component in the predetermined relative position are predetermined as an integral constituent part of the body. A part of the body and of the holding device is manufactured using an additive manufacturing method, such that the component can be positioned in the predetermined relative position in the part of the holding device. The component is positioned in the partially formed holding device. Then the body and/or the holding device is finished using the additive manufacturing method.

### CROSS-REFERENCE TO RELATED APPLICATION

This application claims the priority, under 35 U.S.C. §119, of German patent application DE 10 2014 216 086.3, filed Aug. 13, 2014; the prior application is herewith incorporated by reference in its entirety.

### BACKGROUND OF THE INVENTION

### Field of the Invention

The invention relates to a method for manufacturing an element for a hearing aid, wherein the element has a body and a component which are to be arranged in a predetermined relative position with respect to one another, and to a corresponding component.

Hearing aids are portable hearing systems that serve persons who are hard of hearing. In order to meet the numerous individual requirements, various constructions of hearing aids are available, such as behind-the-ear hearing aids (BTE), hearing aids with external speaker (RIC: receiver in the canal) and in-the-ear hearing aids (ITE), for example concha hearing aids or canal hearing aids (ITE, CIC). The hearing aids which were listed by way of example are worn on the outer ear or in the ear canal. Moreover, bone conduction hearing aids, implantable or vibrotactile hearing aids are also available. Here, the damaged auditory sense is stimulated either mechanically or electrically.

Hearing aids in principle have, as essential components, an input transducer, an amplifier and an output transducer. The input transducer is generally an acousto-electrical transducer, for example a microphone, and/or an electromagnetic receiver, for example an induction coil. The output transducer is typically realized as an electroacoustic transducer, for example a miniature loudspeaker, or as an electromechanical transducer, for example bone conduction speaker. The amplifier is usually integrated in a signal processing device. Power is usually supplied by way of a battery or a rechargeable battery.

Individual parts of the hearing aid are to be fixed in specific positions relative to one another so as to ensure correct function. This applies, for example, to individual microphones which are combined to form a directional microphone and which for this reason must have exactly defined distances.

Furthermore available are special hearing aids that are intended as a system composed of two hearing aids to supply both ears of a person. These are referred to as binaural hearing aids. They differ from a pair of conventional hearing aids by way of a communication connection, preferably wireless, between the two hearing aids, such that settings can be performed synchronously and audio signals can be exchanged for stereoscopic processing. Since only very low electrical powers are available for communication, the antennas must be very sensitive and also have precise alignment with respect to one another when being worn on the head.

In order to precisely fix the position of the antennas in the ear shells (otoplasty), typically an attachment element, for example a ring, in which in turn an antenna coil is arranged, is introduced into a finished ear shell by way of adhesive bonding.

However, positioning the ring in the ear shell with precision is difficult. Moreover, the ear shell offers limited space, such that it is problematic to find the space for the antenna and the additional attachment element inside the otoplastics. This is particularly so if the shell is a shell of an in-the-ear hearing aid (ITE or CIC).

U.S. Pat. No. 5,487,012 furthermore discloses the manufacture of an otoplastic member from multi-piece blanks by way of milling or other ablative methods. The blanks are already provided with recesses, which provide chambers for components such as antennas or speakers by way of connecting, for example adhesively bonding, the multiple pieces.

Commonly assigned U.S. Pat. No. 7,933,425 B2 and its counterpart German published patent application DE 10 2005 046 169 A1 describe a method for manufacturing a hearing aid, in which a housing shell having attachment elements for an antenna is manufactured using the rapid prototyping method. The antenna is inserted together with a speaker in the housing shell during assembly. However, owing to the small structural size, mounting of the antenna is difficult. It is thus already necessary to ensure mountability when arranging the holding device for the antenna, which frequently results in non-optimum positioning of the antenna.

### SUMMARY OF THE INVENTION

It is accordingly an object of the invention to provide a method and device for integrating hearing device components which overcome the above-mentioned and other disadvantages of the heretofore-known devices and methods of this general type and which provide for an improved method for manufacturing elements of a hearing aid, for example an ear shell, which is as easily implementable as possible and provides maximum flexibility with respect to the shape of the element and the position of the component that is to be arranged therein, for example an antenna.

With the foregoing and other objects in view there is provided, in accordance with the invention, a method of manufacturing an element for a hearing aid, the element having a body and a component. The novel method comprises the following steps:

predetermining a relative position of the component on the element;

predetermining a shape and a position of a holding device for the component in the predetermined relative position as an integral constituent part of the body;

manufacturing a portion of the element by way of an additive manufacturing method, the portion of the element including a part of the body and a part of the holding device, the part of the holding device enabling the component to be positioned in the predetermined relative position in the part of the holding device;

positioning the component in the part of the holding device; and

finishing the body and/or the holding device using the additive manufacturing method.

With the above and other objects in view there is also provided, in accordance with the invention, an element for a hearing aid, comprising:

a body;

a component disposed in the body; and

a holding device for the component integrally formed in one piece with the body, the holding device at least partially surrounding the component in three different spatial directions so as to fix a position of the component relative to the element against movement in the three spatial directions.

The method according to the invention relates to a method for manufacturing an element for a hearing aid. The element has a body and a component. The method according to the invention includes the steps of pre-determining a relative position of the component on the element and also a shape and position of a holding device for the component in the predetermined relative position as an integral constituent part of the body. The method moreover includes manufacturing a part of the element using an additive manufacturing method, wherein the part of the element includes a part of the body and a part of the holding device such that the component can be positioned in the predetermined relative position in the part of the holding device. Part in this context is understood to mean that the body and the holding device and consequently also the element are only partially finished. In a further step of the method, the component is arranged in the part of the holding device. Finally, the body and/or the holding device are finished in a step of the method using the additive manufacturing method.

The method according to the invention advantageously allows for the individual design of an element for a hearing aid, for example an ear shell, using an additive method, for example 3D printing. Through provision of a holding device for the component as part of the body of the element, said holding device can be provided integrally in one step with the manufacture of the body. At the same time, the available space is utilized thereby in an optimum fashion and the relative position of component and element is set precisely. If the element is an ear shell and the component is an antenna, the alignment of two antennas in hearing aids of a binaural hearing aid system during correct wearing on the head is also thereby precisely defined. The component is fixed in the holding device by first providing a part of the element and of the holding device, placing the component therein, and subsequently finishing the element and/or the holding device. Advantageously, no more further manufacturing steps or space-consuming auxiliary constructions for positioning the component in the element are necessary.

What is crucial here is that, in a first step, a part of the holding device for the component is first produced with the additive manufacturing method, with the part of the holding device already being suitable for positioning and at least prior fixing. Following the additive manufacturing method, the part of the holding device and the partially finished body, in particular a housing shell of the hearing aid, are composed of the same material in the form of an integral, one-piece part. In the next step, the component is then placed in the holding device. Since the body is only partially manufactured, easy accessibility and thus easy placement of the component are possible. Finally, in a third step, the additive method is subsequently continued and the body and with it the holding device are finished.

The invention also relates to an element for a hearing aid, wherein the element includes a body, a component and a holding device for the component that is produced in one piece with the body. The holding device at least partially surrounds the component in three different spatial directions such that the component is fixed in its position relative to the element against movement in the three spatial directions. The component is fixed by the holding device overall preferably in a positionally fixed manner without play.

The holding device is advantageously manufactured in one piece with the element, which allows low material consumption and low space requirement and ensures good connection between the holding device and the body of the element. Since the holding device surrounds the component in three different spatial directions, for example an x, y and z axis, the component is secured in the element against slipping, such that it advantageously does not leave its position in the component even if exposed to vibrations.

Further advantageous developments of the invention are specified in the dependent claims.

In one conceivable embodiment of the method according to the invention, the part of the element remains in an apparatus for carrying out the additive manufacturing method during the step of positioning the component in the holding device of the element. As compared to positioning after finishing of the body, work steps are omitted and the element can be precisely finished after the positioning of the component without readjustment of the manufacturing device.

In one conceivable embodiment of the method according to the invention, the step of positioning the component in the holding device furthermore comprises ablation of material in the holding device.

It is thus possible to advantageously remove artifacts of the manufacturing method, such as ridges, and to ensure optimum fit of the component.

In the method according to the invention it is also possible that an inlet is left free in the holding device during the steps of manufacturing a part of the body and of the holding device and/or of finishing of the bodies and/or the holding device using the additive manufacturing method. It is thus possible for electrical inlet or outlet lines to be guided to the component or for inlets or outlets for sound to be provided as integral constituent parts of the body and/or of the holding device.

In one possible embodiment of the method according to the invention, the additive manufacturing method is a method for three-dimensional printing.

It is thus possible to use cost-effective and readily available systems for the method, to minimize manufacturing costs and to provide individually different elements.

In one possible embodiment of the method according to the invention, the additive manufacturing method includes a step of applying molten material, sintering or photopolymerization.

Depending on mechanical and chemical requirements of the element, it is thus possible to use optimally suitable materials, such as various plastics, metals or ceramics.

In one embodiment of the element according to the invention, the body and the holding device are produced in one piece using an additive manufacturing method.

A one-piece configuration of the body and holding device provides for maximum strength with minimum outlay in terms of material and production.

In one conceivable embodiment of the invention, the element is a shell for a hearing aid.

The element is advantageously a shell for a hearing aid through which the high requirements in respect of individual fit and low space requirements are fulfilled in an optimum fashion.

In one embodiment of the element according to the invention, it is possible for the holding device to be delimited in only one spatial direction by the body. In other words, a side wall or delimitation of the holding device, by which the component is kept in position, is formed by the body itself in only one spatial direction, while in the other spatial directions structures delimit the holding device that are not predetermined by an outer shape of the element but only by the position of the component, predetermined for the holding device, relative to the element.

It is thus advantageously possible, for example, to provide a holding device which is freestanding in the element and which allows any desired alignment of the component and is not already previously determined by the outer contours of the element, for example by the holding device being formed by a cutout in a wall of the body. The holding device needs to be connected to the body only on at least one side so as to define the alignment and position of the holding device and of the component with respect to the body.

The holding device preferably completely surrounds the component, except for any passage for an electric supply line for the component, if required. The holding device is therefore delimited by solid walls in all spatial directions. For this reason, the component is virtually embedded in the material of the wall of the holding device, similar to a potted element.

The above-described properties, features and advantages of this invention and the manner in which they are achieved become clearer and more easily comprehensible in conjunction with the following description of the exemplary embodiments, which are explained in more detail in connection with the drawings.

Other features which are considered as characteristic for the invention are set forth in the appended claims.

Although the invention is illustrated and described herein as embodied in an apparatus and method for integrating hearing aid components, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows an exemplary schematic illustration of a hearing aid according to the invention;

FIG. 2 shows a partial cross section of an exemplary element of a hearing aid according to the invention;

FIG. 3 shows a partial cross section of an exemplary element of a hearing aid according to the invention; and

FIG. 4 shows a schematic flowchart describing a method according to the invention.

### DETAILED DESCRIPTION OF THE INVENTION

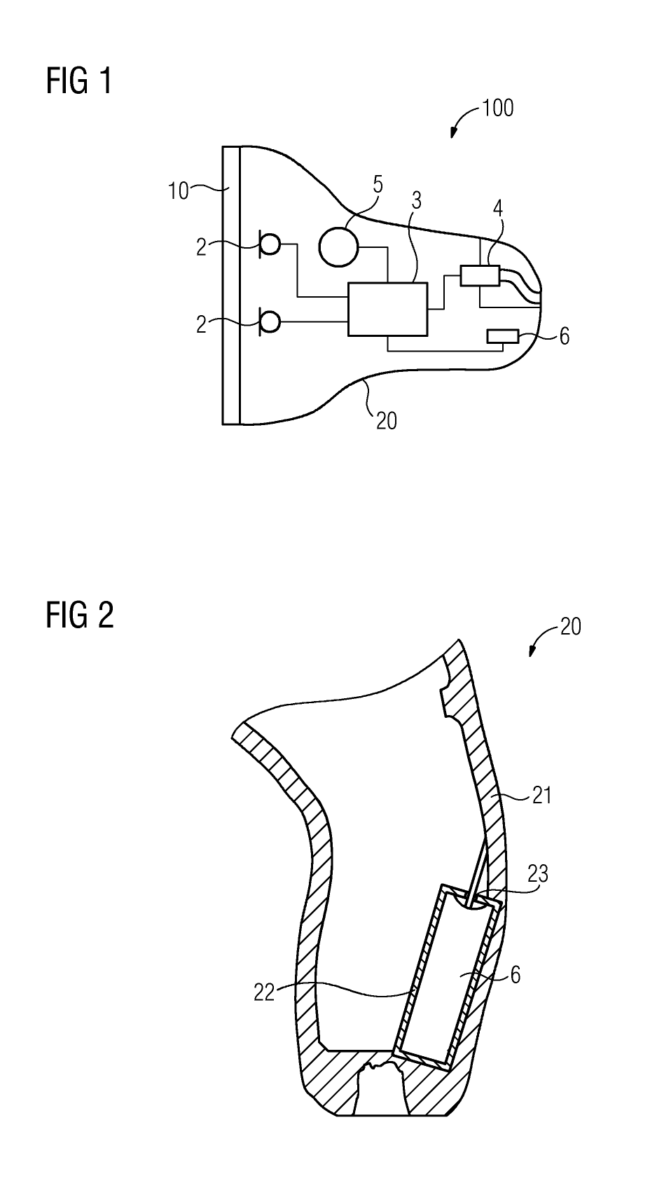

Referring now to the figures of the drawing in detail and first, particularly, to FIG. 1 thereof, there is shown a basic principle construction of a hearing aid 100 according to the invention. One or more microphones 2 are mounted in a hearing aid housing 1. The microphones are also referred to as acousto-electrical transducers 2, for receiving the sound or acoustic signals from the environment. The arrangement of the microphones 2 and the other elements of the hearing aid 100 is illustrated purely schematically and does not represent the spatial arrangement in the hearing aid 100 according to the invention. The hearing aid may in principle be a behind-the-ear (BTE) or in-the-ear (ITE) hearing aid, wherein due to the limited space in the ear canal and its individual shape, the ITE is suitable in particular for the method according to the invention. The microphones 2 are acousto-electrical transducers 2 for converting the sound into first electrical audio signals. A signal processing device 3, which is likewise arranged in the hearing aid housing 1, processes the first audio signals. The output signal from the signal processing device 3 is transmitted to a loudspeaker or speaker 4, which outputs an acoustic signal. In a BTE hearing aid, the sound is transmitted, possibly via a sound tube, which is fixed in the ear canal by way of otoplasty, to the eardrum of the person wearing the hearing aid. However, a different electro-mechanical transducer is also conceivable, such as for example a bone conduction speaker. The hearing aid and in particular the signal processing device 3 are supplied with power by way of a battery 5, which is likewise integrated in the hearing aid housing 1.

The hearing aid 100 furthermore has a component 6, which is a transmission device for transmitting information to a second hearing aid. Exact alignment of the transmission device 6 with a corresponding transmission device 6 of the other hearing aid is necessary for optimum transmission.

The hearing aid 100 has a housing, formed by a shell or element 20 and a cover 10, here a faceplate. FIG. 2 illustrates a partial cross section of the element 20, with the element 20 in the exemplary illustration of FIG. 2 being a shell of an ITE hearing aid.

The element 20 has a body 21 which, for a shell of an ITE hearing aid 100, is individually molded to the ear canal of the wearer. A component 6—in the illustrated example the transmission device—is arranged in the element 20. So as to fix the component 6 at the predetermined position, it is surrounded by a holder 22 or holding device 22, which is produced in one piece with the body 21. In the example of FIG. 2, the bottom and the right-hand lateral wall of the holding device 22 are at the same time part of the body 21.

The component 6 is here surrounded on all sides, i.e., in three different spatial directions or coordinates, by the holding device 22 such that its position and alignment is secured in all three coordinate directions, and the position relative to the body 21 does not change even if it is exposed to strong vibrations.

By making a lateral delimitation of the holding device 22 a part of the wall of the body 21 in the embodiment of FIG. 2, the space inside the body 21 can be utilized in an optimum fashion since a wall is dispensed with.

The holding device 22 has a passage 23 at one location, at which, for example, an electric line extends through, if the component 6 is a transmission device.

What is characteristic for the element 20 according to the invention is that the holding device 22 and the body 21 are not manufactured by connecting two or more partial elements, for example by way of adhesive bonding, but are manufactured in one piece.

The characteristic features such as material and surface texture, in particular of the inner surfaces of the body 21, make it possible here to determine whether the body 21 with the holding device 22 was produced in an additive manufacturing method, for example using polygonal, cuboid or layer-type structures which are brought about by individual volume elements of a 3D printer.

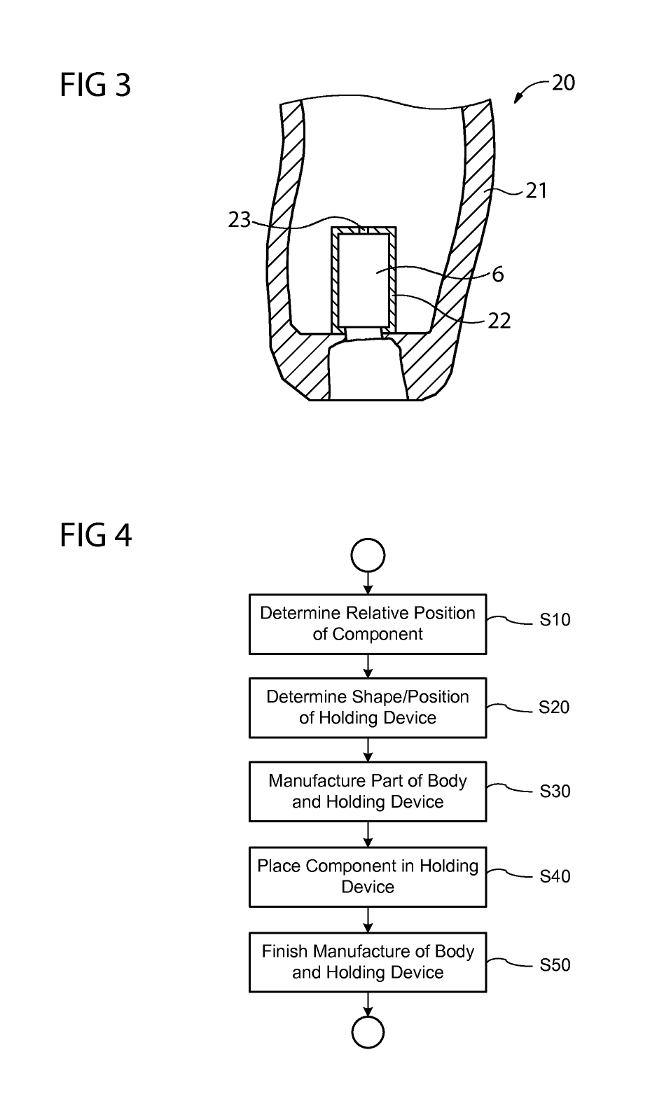

FIG. 3 illustrates a partial cross section of a further exemplary element 20 according to the invention. Identical objects are designated with the same reference numerals as in FIG. 2.

The element 20 in FIG. 3 differs from the element 20 in FIG. 2 substantially by the fact that the holding device 22 is connected to the body 21 only by the edge that is bottommost in the figure. The lateral and upper delimitations of the holding device 22 are free in space and not directly connected to the body 21, with the result that the alignment of the holding device 22 relative to the body 21 can be chosen freely within the limits of the space available in the body 21.

FIG. 4 illustrates a schematic flowchart of a method according to the invention for manufacturing an element 20 according to the invention for a hearing aid, wherein the element 20 has a body 21 and a component 6.

In step S10, a relative position of the component 6 on the element 20 is predetermined. If the element 20 is for example a shell of an ITE hearing aid, first the ear canals of the wearer are individually captured. To this end, the ear canal can be represented by way of a mold or be captured using three-dimensional scanning. Furthermore, the relative position of the two ear canals with respect to one another must be captured, either using mechanical, optical or imaging methods. If the component 6 is, for example, a transmission device, the position and alignment of the component 6 in the body of the element 20 can be predetermined from the obtained data such that an axis of maximum receiving sensitivity of the transmission device is aligned with the respectively other transmission device in the other ear. In the case of an antenna coil, this is for example an axis perpendicular to the transverse section of the coil.

In step S20, a shape and position of the holding device 22 for the component 6 in the predetermined relative position is predetermined as an integral constituent part of the body 21. It is conceivable for example to choose for the holding device 22 a shape which surrounds the known component 6 on the outside with a specific thickness of a material of the body 21 in the predetermined position and alignment. If the antenna coil is cylindrical, for example, the holding device 22 can also be a hollow cylinder, the internal diameter of which corresponds just to the external diameter of the antenna coil. However, it is also conceivable for the component 6 to be not entirely enclosed by the holding device, but for the component to remain accessible in some areas. The shape of the holding device can also form a type of cage which surrounds the component 6 in all three spatial directions, with the result that the component 6 can still be held in the predetermined position relative to the body.

In step S30, a part of the body and of the holding device is manufactured using an additive manufacturing method. The body in FIG. 2 or 3 can be constructed on a placement area layer-by-layer from the bottom up on the basis of the predetermined shape and position, using the additive manufacturing method, for example by way of a 3D printer. Here, first the bottom part of the body with the opening toward the eardrum is produced. Subsequently, the external walls of the body 21, which rest against the ear canal, are built up on the bottom. At the same time, lateral delimitations of the holding device 22 are constructed in the body 21. The process of layer-wise construction is interrupted before the holding device 22 is terminated toward the top by a structure, such that first the component 6 can be introduced into the holding device 22.

The time at which step S30 takes place depends on the shape of the component 6, on the alignment of the holding device 22 relative to the body 21, and on the manufacturing method used. In a 3D printer, which deposits horizontal layers from the top, the component 6 can be introduced in the holding device only after all areas of the holding device having undercuts with respect to the component 6 are established, that is to say regions which, from the view of a printing head from above, are concealed behind the component 6.

It is then possible in step S40 for the component to be positioned in the predetermined relative position in the part of the holding device. However, it is also conceivable for material of the holding device to be removed in this step S40, for example ridges from the additive manufacturing method.

During step S40, the element 20 advantageously remains in the apparatus for carrying out the additive manufacturing method, such that no repositioning is necessary after removal and insertion. This speeds up the manufacturing process and increases accuracy.

Once the component 6 is situated in the predetermined position in the holding device 22, the manufacturing process can continue. In step S50, the body 21 and/or the holding device 22 are finished using the additive manufacturing method. It is conceivable, depending on the shape of the element 20, that only the holding device 22 or the body 21 still need to be finished.

If the component 6 is a component which has, for example, electrical connections or a component which requires an inlet/outlet for sound, a passage 23 can be arranged in step S20 or S50, depending on the position in the holding device 22.

Conceivable additive manufacturing methods are printing using a 3D printer using molten polymers, layer-wise deposition of a liquid synthetic resin using photopolymerization, or layer-wise sintering or melting techniques using a laser for ceramic or metallic powders and other methods.

Although the invention was illustrated and described in more detail by the preferred exemplary embodiment, the invention is not limited by the disclosed examples, and other variants can be derived therefrom by the person skilled in the art without departing from the scope of protection of the invention.

1. A method of manufacturing an element for a hearing aid, the element having a body and a component, the method comprising the following steps:
predetermining a relative position of the component on the element;
predetermining a shape and a position of a holding device for the component in the predetermined relative position as an integral constituent part of the body;
manufacturing a portion of the element by way of an additive manufacturing method, the portion of the element including a part of the body and a part of the holding device, the part of the holding device enabling the component to be positioned in the predetermined relative position in the part of the holding device;
positioning the component in the part of the holding device; and
finishing the body and/or the holding device using the additive manufacturing method.

2. The method according to claim 1, which comprises carrying out the manufacturing and finishing steps with an apparatus for additive manufacturing and, during the positioning step, retaining the part of the element in the apparatus for additive manufacturing.

3. The method according to claim 1, wherein the positioning step further comprises ablation of material in the holding device.

4. The method according to claim 1, wherein the manufacturing step and/or the finishing step comprises leaving an inlet free in the holding device.

5. The method according to claim 1, wherein the additive manufacturing method is a method for three-dimensional printing.

6. The method according to claim 5, wherein the additive manufacturing method includes a step of applying molten material, sintering or photopolymerization.

7. An element for a hearing aid, comprising:
a body;
a component disposed in said body; and
a holding device for said component integrally formed in one piece with said body, said holding device at least partially surrounding said component in three different spatial directions so as to fix a position of said component relative to the element against movement in the three spatial directions.

8. The element according to claim 7, wherein said body and said holding device have the characteristics of having been produced in one piece by an additive manufacturing method.

9. The element according to claim 7, formed as a shell for a hearing aid.

10. The element according to claim 7, wherein said holding device is delimited in only one spatial direction by said body.

11. The element according to claim 7, wherein said holding device completely surrounds said body, except for a passage for an electric supply line.
